(19) United States
(12) Patent Application Publication
(10) Pub. No.: US 2021/0363807 A1
(43) Pub. Date: Nov. 25, 2021

(54) VEHICLE COMPONENT AND METHOD

(71) Applicant: INVENTUS ENGINEERING GMBH, ST. ANTON I.M. (AT)

(72) Inventor: STEFAN BATTLOGG, ST. ANTON I.M. (AT)

(21) Appl. No.: 17/252,106

(22) PCT Filed: Feb. 11, 2019
(86) PCT No.: PCT/EP2019/053330

§ 371 Date: Dec. 14, 2020

(30) Foreign Application Priority Data
Feb. 13, 2018 (DE) 10 2018 103 121.1

(51) Int. Cl. E05F 15/41; E05F 15/53; B60J 5/04; E05F 15/73

(52) U.S. Cl. CPC E05F 15/41; E05F 15/53; E05Y 2900/531; E05F 15/73; E05F 2015/765; B60J 5/047

(57) ABSTRACT

A vehicle component has a sensor device and a controllable damper device for damping a movable door. The sensor device includes a sensor for detecting a characteristic parameter for an obstacle in a movement area of the door. The damper device can be actuated in a manner which is dependent on the parameter. A monitoring device is provided which, in order to detect a characteristic parameter for a manipulation of the vehicle, for example damage of a vehicle exterior shell or removal of a vehicle interior compartment, is operatively connected to the sensor device, in order for the latter to be interrogated.

The present invention relates to a vehicle component, in particular for a motor vehicle, having at least one sensor device and having at least one controllable damping device for damping a movable door device as well as a method for operating such a vehicle component.

Damping devices that are controlled via sensor systems have become known in order to enable car doors to be opened and closed in a particularly safe manner. It is thus possible, for example, to monitor the gap when the door is open and to then increase the door damping if there is a risk of getting caught. Some sensor systems can also detect obstacles when opening the door such that, when getting out of the car, the door does not hit adjacent vehicles or collision objects in the opening region or even such that passers-by are not injured.

The known door dampers function reliably in themselves and also enable car doors to be safely opened and closed thanks to the corresponding sensor system. However, door damping controlled by sensors also usually entails a considerable cost factor. The known systems are thus often not used when manufacturing cars so as not to negatively affect the economic viability of a car on offer.

It is the object of the present invention to detect a manipulation of the vehicle, for example damage to a vehicle outer shell or a removal of a vehicle interior component, preferably in a vehicle having a door device having a damping device which enables car doors to be opened and closed in a safe and convenient manner and thus has extended sensor devices, and thus overall achieve an improved cost-benefit ratio of the door device or damping device and be able to use these in particular in a more cost-effective manner.

This object is achieved by a vehicle component having the features of claim 1. Methods according to the invention are the subject of claim 19, claim 20 and claim 21. Preferred further developments of the invention are the subject of the dependent claims. Preferred features, further developments and embodiments are also outlined in the general description and the description of the exemplary embodiments.

The vehicle component according to the invention is provided in particular for a motor vehicle and comprises at least one sensor device and at least one controllable damping device for damping a movable door device. The sensor device comprises at least one sensor means for detecting at least one characteristic variable for an obstacle in a movement space of the door device. The damping device can be controlled as a function of the variable. At least one monitoring device is provided here. The monitoring device is, for the purpose of detecting at least one characteristic parameter for a manipulation of the vehicle, at least partly operatively connected to the sensor device in order to be able to access it.

The vehicle component according to the invention offers many advantages. One considerable advantage is that the sensor device can also be used for monitoring manipulations of the vehicle. This considerably increases the usefulness of the sensor device and it extends nor only to the detection of obstacles in the movement space of the door device but also to monitoring of the vehicle.

The vehicle component according to the invention thus offers a very safe and convenient door damping with an advantageously optimized cost-benefit ratio. The vehicle component according to the invention can thus be integrated into vehicles in a particularly cost-effective manner.

The monitoring device is preferably suitable and designed for detecting the characteristic parameter for the manipulation at least partly using the sensor means. The monitoring device is also preferably operatively connected at least partly with the sensor means of the sensor device.

In particular, the monitoring device is suitable and designed for evaluating the characteristic parameter for the manipulation and detecting a manipulation and/or a threat of manipulation based on an evaluation. By way of example, a threat of manipulation is detected if the characteristic parameter exceeds at least one threshold. If the threshold is exceeded by a specific amount, it can be assumed that manipulation has occurred and, for example, there has been a collision.

Within the scope of the evaluation, the detected parameter can be subjected to at least one signal processing event and, for example, one filtering event. It is also possible that the evaluation comprises at least one plausibility check of the detected parameter in order to counteract a false positive detection of a manipulation, for instance.

It is, however, also possible that the monitoring device merely detects the characteristic parameter and in particular does not evaluate it for the detection of a manipulation. By way of example, the parameter can be continuously recorded by image recordings, regardless of whether there is any manipulation or not. The recordings are then evaluated, for example, by the owner of the vehicle and not by the monitoring device.

In particular, the monitoring device is suitable and designed for monitoring a stationary or parked vehicle. But it is also possible that the monitoring device is suitable and designed for monitoring a moving vehicle.

In particular, the sensor device comprises at least one image sensor for detecting the characteristic variable for the obstacle and/or for detecting the characteristic parameter for the manipulation. An image sensor or image recognition system enables obstacles and manipulations to be detected in a particularly reliable and reproducible manner. The image sensor can, for example, detect image data in the spectrum of visible light and/or in the infra-red range. The monitoring device is in particular suitable and designed for detecting a manipulation based on at least one image analysis of the characteristic parameter detected by the image sensor.

In particular, the sensor means comprises the image sensor or the image sensor provides the sensor means. The image sensor may also only be provided for detecting the characteristic parameter for the manipulation.

The monitoring device preferably comprises at least one camera device for recording image data from at least one region of the vehicle and/or the vicinity of the vehicle. A camera device of this type is particularly good at determining a cause of a manipulation by recording image data. In particular, the camera device is suitable and designed for storing the recorded image data on at least one storage medium at least temporarily and preferably for a longer period of time or permanently.

The camera device can be designed as an interior camera for the vehicle interior or the passenger compartment. The camera device can be designed as an exterior camera. The camera device can be suitable and designed for recording image data from the vehicle interior or from the passenger compartment. The image sensor can be provided by the interior camera and/or exterior camera.

The camera device can be operatively connected to at least one output device, e.g. via a wireless connection. The recordings can then be viewed and/or the recordings can be stored via the output device. The output device is, for example, an on-board computer, computer, smartphone, smartwatch and/or tablet or the like.

In particular, the image data is stored together with data on time and/or location. GPS-based position data can also be stored together with the image data. The camera device can also be designed at least partly as a thermal imaging camera or can at least comprise same. A thermal imaging camera is particularly well suited for detecting persons in the vehicle interior or for identifying vehicles with the engine running.

In one particularly preferred embodiment, the image sensor of the sensor device at least partly provides an image sensor for the camera device.

The sensor device and camera device thus comprise in particular one and the same image sensor. Such an embodiment is particularly cost-effective as the image sensor can be used both for detecting the manipulation or obstacle and also for recording incidents of damage. However, it is also possible that the sensor device and camera device respectively comprise at least one image sensor of their own.

It is possible here that the image sensor can be operated in a different operating mode for detecting the parameter or variable than for recording image data with the camera device. In particular, a different resolution and/or data depth and/or image frequency is provided for detecting the parameter and/or variable than for recording image data for the camera device. This has the advantage of enabling the sensor device to be operated in a particularly energy-efficient manner and at the same time of providing detailed and meaningful recordings of incidents of damage.

The camera device can particularly preferably be controlled as a function of the characteristic parameter. In particular, the camera device can be activated and/or deactivated as a function of the characteristic parameter. No image data is, in particular, recorded when a camera device is deactivated. Such an embodiment has the advantage that the camera device is only active and consumes energy when the characteristic parameter points to a manipulation or the monitoring device has already detected a manipulation. Controlling the camera device as a function of the characteristic parameter can comprise switching to a higher resolution and/or data depth and/or image frequency or the like.

In particular, the camera device can be activated from an energy-saving mode as soon as the parameter exceeds at least one threshold. By way of example, the characteristic parameter is detected by means of a distance sensor and the camera device is in particular activated if the distance sensor indicates that a vehicle has approached to a certain distance.

The camera device can preferably be controlled in such a manner that recorded image data is discarded if no manipulation is detected within a defined time window. The camera device can preferably be controlled in such a manner that image data from a defined time window is permanently stored if a manipulation is detected. The time window is, for example, a few seconds or a few minutes or a few hours or more. In particular, the time window is adjusted to the storage capacity or image data volume.

In particular, image data from at least one perspective of a vehicle rear and/or a vehicle front and/or vehicle side and/or a vehicle roof and/or exterior mirror and/or vehicle rocker panel and/or vehicle interior can be recorded with the camera device. This enables incidents of damage to be particularly well documented. In particular, image data can be recorded from at least two and preferably more different perspectives. In particular, the camera device comprises at least one wide-angle lens and/or telephoto lens and/or zoom lens.

The camera device can also at least partly be assigned to a back-up camera device. This further improves the cost-benefit ratio.

In one advantageous embodiment, the monitoring device is suitable and designed for issuing at least one alarm as a function of the characteristic parameter. In particular, an acoustic and/or visual and/or haptic alarm is provided. By way of example, the vehicle may sound its horn and/or flash its lights. The alarm can also comprise at least one piece of text information.

The alarm can be issued wired and/or wirelessly on at least one output device and, for example, a smartphone and/or a key fob of the vehicle. The alarm can be forwarded together with a recording captured by the camera device. In this case, a live recording and/or a recorded or saved recording can be used.

In order to issue the alarm to the output device, the monitoring device preferably comprises at least one mobile radio device and in particular also at least one SIM card. It is possible that the monitoring device uses a SIM card already built into the vehicle for this purpose. Such an embodiment has the advantage that the owner of the vehicle is informed of an incident of damage particularly quickly.

The monitoring device can particularly preferably be operated in at least one economy mode with a reduced monitoring intensity. The monitoring device can also preferably be operated in at least one power mode with an increased monitoring intensity. In particular, the monitoring intensity is reduced in economy mode compared to power mode. A maximum monitoring intensity can be provided in power mode. Economy mode provides, for example, a particularly low energy consumption such that monitoring even over prolonged periods of time is possible without significantly impairing the vehicle battery.

In particular, the monitoring device is suitable and designed for setting the economy mode and/or power mode as a function of at least one parking position of the vehicle. The parking position can be detected in particular using at least one GPS signal and/or another suitable position detection signal. The monitoring device can therefore automatically recognize, for example, whether the vehicle is parked at a particularly at-risk location for parking damage, for example in a public parking lot such as a furniture store parking lot.

The monitoring device can also detect whether the vehicle is parked in a garage of the owner and requires no or only a little monitoring.

It is also possible that the monitoring device is suitable and designed for setting the economy mode and/or power mode as a function of at least one user input and/or as a function of at least one monitoring duration. The monitoring duration is, for example, the duration of at least one preceding monitoring event and/or at least one planned monitoring event. This means that a prolonged monitoring duration, such as when parking at the airport, can occur in economy mode such that the vehicle battery can be preserved. It is possible that the monitoring device is suitable and designed for prompting the user for the user input. By way of example, the prompt may occur when the user parks the vehicle. For example, an input of the parking duration can be provided.

It is preferable that the monitoring device is suitable and designed for switching from economy mode to power mode as a function of the characteristic parameter. In particular, the monitoring device is suitable and designed for automatically switching to economy mode as soon as at least one manipulation can be detected based on the parameter. By way of example, switching from economy mode to power mode can occur when at least one threshold of the parameter is exceeded. Such embodiments enable an intelligent adaptation of the sensor device call up. The monitoring device can thus be operated in economy mode until the sensor device detects a threat of manipulation based on the characteristic parameter.

The monitoring device is preferably suitable and designed for accessing the sensor device only at a certain part and/or with a reduced frequency and/or with a reduced duration in order to reduce the monitoring intensity in economy mode. Intensity or resolution can thus be well adapted to a reduced energy consumption, for instance.

By way of example, the sensor device comprises a plurality of sensors, wherein only predetermined sensors are called up in economy mode. In particular, the camera device is deactivated in economy mode such that image data is not captured.

At least one shock sensor and/or acceleration sensor and/or at least one noise sensor of the sensor device can preferably be accessed by the monitoring device in economy mode. Such sensors generally need particularly little energy and can at the same time reliably detect manipulations such that they are particularly well suited to operation in economy mode. The noise sensor and/or the shock sensor can also preferably be accessed in power mode.

In all embodiments, it is preferable that the monitoring device is suitable and designed for processing the parameter detected by the sensor device, in particular by the shock sensor and/or noise sensor using at least one filter. This has the advantage that a filtered parameter is available for control or for detecting manipulations. By way of example, the filter can be used to distinguish between traffic noise or traffic vibrations and noises or vibrations caused by collisions.

It is possible that the monitoring device is suitable and designed for detecting at least one charging operation of an electrical energy storage device for a traction drive of the vehicle and as at least one consequence of the detection setting the power mode. It is, however, also possible that the monitoring device remains in economy mode during a charging operation.

In particular, the sensor device comprises at least one sensor and preferably a plurality of sensors. In this case, at least one sensor of the sensor device is preferably intended to both detect the characteristic parameter and to detect the characteristic variable.

In all embodiments, it is preferred that the sensor device for detecting the characteristic parameter for the manipulation has at least one sensor from a group of sensors, wherein the group comprises an image sensor, proximity sensor, shock sensor, noise sensor, ultrasonic sensor, infra-red sensor, heat sensor, radar sensor, movement sensor, force sensor, pressure sensor, strain sensor, angle of rotation sensor, acceleration sensor, vibration sensor. In particular, the sensor device comprises at least two and preferably a plurality of these sensors.

The sensor means particularly preferably also comprises at least one sensor and in particular a plurality of sensors from this group of sensors. At least one sensor from this group of sensors is thus preferably available both as a sensor means for detecting the variable for the obstacle and also as a sensor for detecting the characteristic parameter for the manipulation. This at least one sensor is thus collectively used by the damping device and the monitoring device and is operatively connected to both.

The characteristic parameter for the manipulation and the characteristic variable for the obstacle are in particular provided by the respective sensor signals of the sensors.

In one advantageous embodiment, the damping device is suitable and designed for determining at least one measure for a rate of change of the movement speed of the door device based on the sensor means and in the case of a rate of change above a predetermined threshold switching from a currently set low damping to a higher damping. This enables the car door to be operated considerably safely. Serious physical injuries and severe damage of objects can be largely avoided.

For this purpose, the sensor means comprises in particular at least one damping sensor which is arranged in and/or on the damping device. By way of example, the damping sensor is designed as an angle of rotation sensor.

In this case, the rate of change of the rotational speed is understood to be the mathematical derivative of the rotational speed, i.e. the acceleration or deceleration. This means that if the change in rotational speed is excessive, the control system intervenes in the damping behavior of the damping device. The mathematical amount of the rate of change is taken into account here. The thresholds for deceleration and acceleration both for opening and for closing can be the same, but are preferably different.

The monitoring device can be suitable and designed for evaluating the measure for a rate of change of the movement speed of the door device detected with the sensor means as a parameter for a manipulation. The monitoring device can be suitable and designed, if the door device is closed and/or if the door device has not been actuated, for detecting a rate of change above a predetermined threshold as a manipulation. In such an embodiment, the sensor means facilitates a high degree of safety when damping the door and at the same time provides added value through use with the monitoring device.

The damping device preferably comprises at least one magnetorheological fluid as operating fluid and at least one electrically adjustable magnetorheological damping valve, which keeps its set state de-energized, or in particular at least one damping unit of this type. In particular the damping device is suitable and designed for permanently setting a damping property of the damping device as required, and particularly preferably setting it in real time, via an electrical setting of the damping valve or damping unit. This enables the door damping to be set quickly and reliably as a function of the sensor signals.

The damping device comprises in particular at least two connection units that can be moved relative to each other. In particular, one of the two connection units can be connected to a support structure and the other of the two connection units to the movable door device, in order to damp a movement of the door device at least partly between a closed position and an open position in a controlled manner with a control device.

The method according to the invention is intended for operating a vehicle component having at least one sensor device and having at least one controllable damping device for damping a movable door device. The sensor device comprises at least one sensor means. At least one characteristic variable for an obstacle in a movement space of the door device is detected with the sensor means. The damping device is controlled as a function of the variable. In this case, at least one characteristic parameter for a manipulation of the vehicle, for example damage to a vehicle outer shell or a removal of a vehicle interior component, is also detected with the sensor device, in particular with the sensor means. The parameter is made available to at least one monitoring device.

The method according to the invention also provides the advantage of very economical and simultaneously safe door damping. In addition, economical and straight-forward monitoring of a vehicle is achieved, e.g. in terms of parking damage or theft of components. Since the sensor system of the damping device is also used by the monitoring device, an inexpensive cost-benefit ratio of these components is achieved.

The method is preferably configured such that it is also suitable for operating the vehicle component or its further developments. The vehicle component according to the invention is preferably suitable and designed for implementing the method. In particular, the monitoring device also accesses the sensor means at least temporarily. In particular, the monitoring device and the damping device, in particular a control device of the damping device, evaluate a sensor signal of the same sensor.

Another method according to the invention is intended for preventing damage to a vehicle having a vehicle component having at least one sensor device and having at least one controllable damping device for damping a movable door device. The sensor device comprises at least one sensor means. At least one characteristic variable for an obstacle in a movement space of the door device is detected with the sensor means. The damping device is controlled as a function of the variable. In this case, at least one characteristic parameter for a manipulation of the vehicle, for example damage to a vehicle outer shell or a removal of a vehicle interior component, is detected and evaluated with the sensor device, in particular with the sensor means, and as a result the vehicle autonomously attempts to prevent the manipulation of or damage to the vehicle.

This method too achieves the above-mentioned object particularly advantageously. The method is preferably used for a driverless or autonomous vehicle. The method is preferably configured such that it is also suitable for operating the vehicle component or its further developments. The vehicle component according to the invention is preferably suitable and designed for implementing the method. The method can be configured as a further development of the method according to the invention described above.

A further method according to the invention is intended for documenting damage to a driverless vehicle having a vehicle component having at least one sensor device and having at least one controllable damping device for damping a movable door device. The sensor device comprises at least one sensor means. At least one characteristic variable for an obstacle in a movement space of the door device is detected with the sensor means. In this case, at least one characteristic parameter for a manipulation of the vehicle, for example damage to a vehicle outer shell or a removal of a vehicle interior component, is detected and/or evaluated with the sensor device, in particular with the sensor means.

This method too achieves the above-mentioned object particularly advantageously. The method is preferably used for a driverless or autonomous vehicle. The method is preferably configured such that it is also suitable for operating the vehicle component or its further developments. The vehicle component according to the invention is preferably suitable and designed for implementing the method. The method can be configured as a further development of the method according to the invention described above.

The applicant reserves the right to claim a vehicle component which comprises in particular at least one controllable damping device for damping a door device and at least one sensor means for detecting at least one characteristic variable for an obstacle in a movement space of the door device. The damping device can in particular be controlled as a function of the variable. In this case, the vehicle component comprises in particular at least one monitoring device having at least one sensor device for detecting at least one characteristic parameter for a manipulation of the vehicle. In particular, the sensor device is at least partly provided by the sensor means of the damping device.

Within the scope of the invention presented here, a door device is understood to mean, as well as a door of the passenger compartment, also a tailgate or trunk lid and/or an engine compartment cover or the like. The door device can also be designed as another opening device, such as a convertible roof.

In all embodiments, it is possible that a drive (e.g. an electric motor) is comprised, which enables the door device to be opened and/or closed completely and/or partly in a controlled manner. For this purpose, the drive can be coupled with the damping device. A linear movement can be converted into a rotary movement and vice versa.

Further advantages and features of the present invention result from the description of the exemplary embodiments which are outlined below with reference to the appended figures.

In the figures:

FIG. 1 shows a schematic plan view of a vehicle with a vehicle component according to the invention;

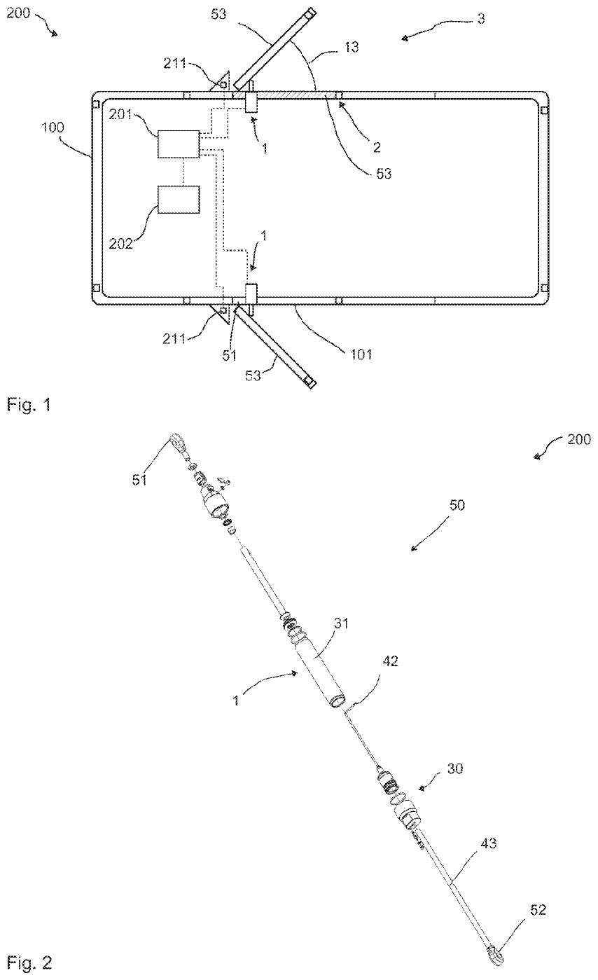

FIG. 2 shows a schematic exploded view of a damping device of the vehicle component;

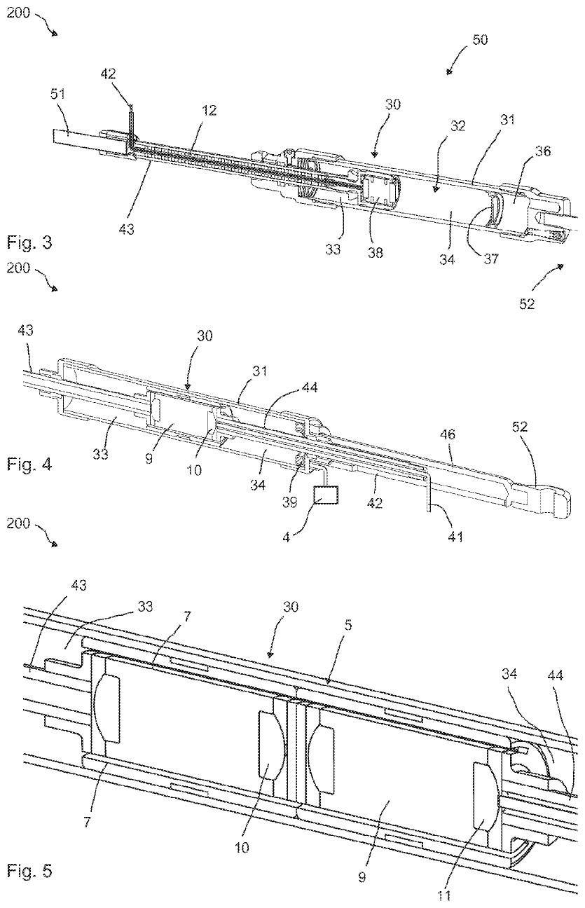

FIG. 3 shows an enlarged cross-section of the damping device according to FIG. 2;

FIG. 4 shows another embodiment of a damping device;

FIG. 5 shows a further embodiment of a damping device;

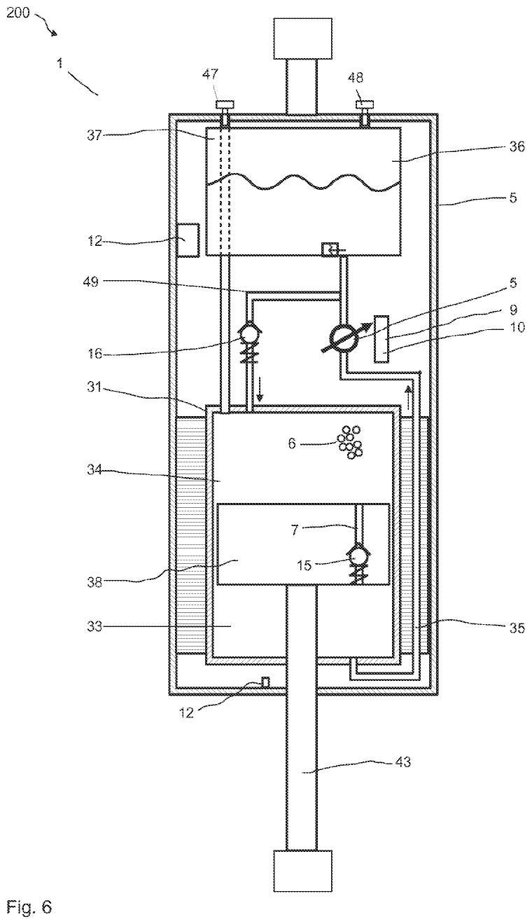

FIG. 6 shows yet another embodiment of a damping device;

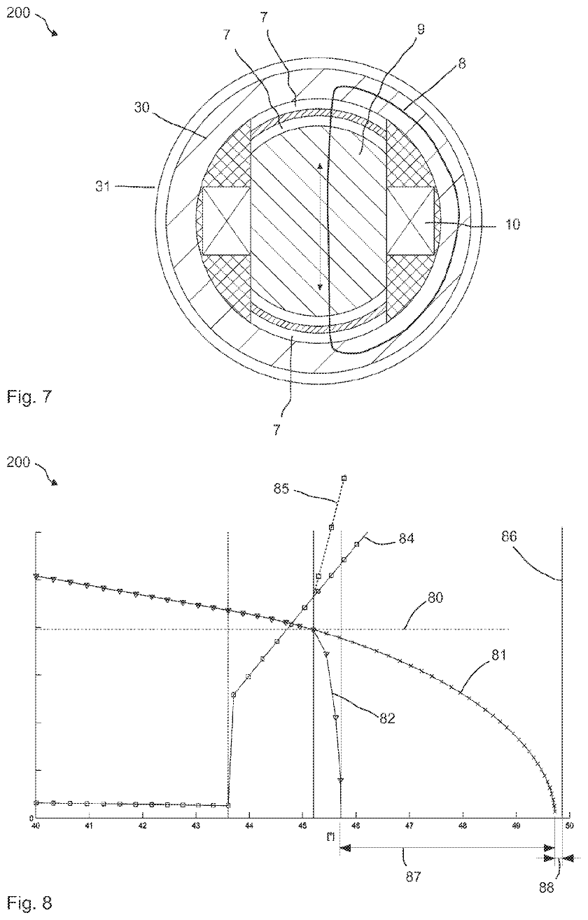

FIG. 7 shows a schematic cross-section through a damping valve of a damping device of a vehicle component according to the invention;

FIG. 8 shows a diagram showing the speed and deceleration of a door during a closing operation; and

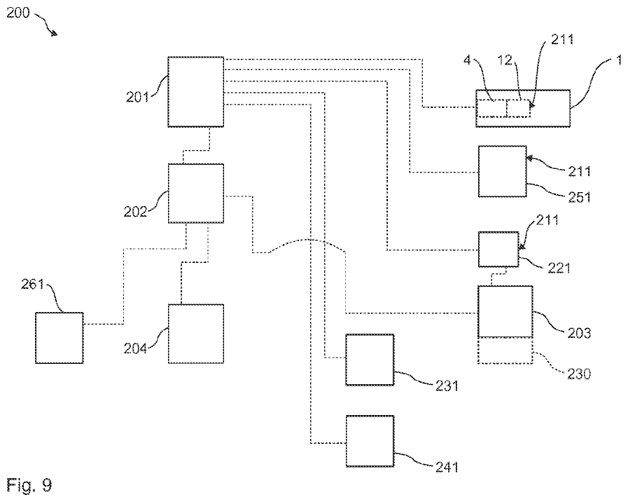

FIG. 9 shows a highly schematic diagram of an interconnection of the vehicle component.

FIG. 1 shows a schematic plan view of a stationary or parked motor vehicle 100 at a roadside with a vehicle component 200 according to the invention. The vehicle component 200 is operated here in accordance with the method according to the invention.

The vehicle 100 comprises here two door devices 50 designed as doors 53, which are both open. The doors 53 are respectively in an angular position 13 shown by way of example.

The door devices 50 are part of the vehicle component 200 here. It is equally possible that one or several door devices 50 are attached to the vehicle component 200.

The door device 50 in any case comprises connection units 51 and 52 for connecting to a corresponding support structure 101 of the vehicle 100 or to the door 53 to pivotally receive the door 53 on the support structure 101. In this case, the door 53 can consist of several units, each of which can be pivoted and which are connected to one another in an articulated manner. The door 53 can be pivotally received on one or on two or more pivot axes. The hatched area shows a door 53 in the closed position 2 in which the door 53 is flush with the vehicle 100 here.

In order to dampen an opening and/or closing movement in a targeted manner, the door devices 50 here are respectively equipped with a controllable damping device 1. The damping device 1 is described in more detail with reference to FIGS. 2-8.

The door devices 50 are here assigned a sensor device 201 in order to detect obstacles in a movement space of the doors 53. For this purpose, the sensor device 201 here comprises a sensor means 211 for each door device 50, which sensor means 211 detects at least one characteristic variable for obstacles in the movement space.

By way of example, the variable can correspond to a signal course of an ultrasonic signal or a radar signal which is reflected by an obstacle. For this purpose, the sensor means 211 comprises, for example, one or more ultrasonic or radar sensors. It is also possible that the sensor means 211 comprises at least one force sensor and/or acceleration sensor or deceleration sensor. The variable then corresponds to the sensor signal of the respective sensor. The sensor means 211 can also be equipped with one or more other sensor types which enable obstacles to be detected.

The damping device 1 is operatively connected with the sensor device 201 here such that the damping device 1 can be controlled as a function of the detected variable. For example, a greater or maximum damping can thus be immediately set if the door 53 risks hitting or hits an obstacle when it is opened or closed.

The vehicle component 200 according to the invention comprises here a monitoring device 202 for monitoring the vehicle 100. By way of example, parking damage or personal injury caused by other road users can be detected with the monitoring device 202.

In this case, the vehicle component 200 according to the invention provides the specific advantage that the monitoring device 202 can also rely on the sensor device 201. As such, the sensor means 211 which is intended to detect the variable for the obstacle in the movement space of the door device 50 can also be used to detect at least one characteristic parameter for a manipulation of the vehicle 100. The cost-benefit ratio of the damping device 1 is therefore improved in particular in terms of cost-saving as the sensor means 211 also serves the monitoring device 202 and thus has a considerably broader scope of use. Moreover, the monitoring device 202 does not have to have a costly sensor system of its own integrated.

The monitoring device 202 is operatively connected with the sensor device 201 here and accesses at least some of the sensors connected thereto in order to detect the parameter for the manipulation of the vehicle 100. In doing so, the monitoring device 202 also accesses the corresponding sensor signals of the sensor means 211. The sensor signal of the sensor means 211 thus not only delivers a characteristic variable for the obstacle but also a characteristic parameter for the manipulation of the vehicle 100.

If the sensor means 211 comprises, for example, an ultrasonic sensor or radar sensor, the monitoring device 202 can also use the ultrasonic signal or radar signal to detect an approaching vehicle which could cause damage to the vehicle outer shell.

The sensor means 211 can also be equipped with a force sensor and/or acceleration sensor or deceleration sensor such that the monitoring device 202 can use the sensor signal to detect an impact on the vehicle 100. Parking damage can thus be reliably detected, for instance.

The vehicle component 200 can also comprise other sensors (not shown here) for detecting the parameter. These sensors may only be provided for the monitoring device 202. However, it is also possible that the sensors are also used as a sensor means 211 for detecting the variable for the obstacle in the movement space of the door device 50.

The sensor means 211 can be accessible both by the damping device 1 and also by the monitoring device 202 simultaneously or in parallel. The sensor means 211 can, however, also only be accessible by the damping device 1 or the monitoring device 202 with a time delay. By way of example, a priority for the damping device 1 can be provided during opening and closing operations of the door device 50 such that the sensor means 211 is then available to detect obstacles.

In an exemplary use of the vehicle component 200, the vehicle 100 is parked in a parking lot. If the driver opens the door 53 to get out, the opening movement is damped by the damping device 1. If the sensor means 211 now detects an obstacle in the movement space of the door 53, the damping is set to a maximum or blocked. The driver can no longer easily open the door 53 now, such that an impact with the obstacle is prevented or heavily damped.

The sensor means 211 also detects obstacles whilst the door 53 is closed. This therefore effectively prevents body parts getting trapped in the door, for instance.

Whilst the vehicle 100 is parked, the monitoring device 202 is active and detects the characteristic parameter for a manipulation of the vehicle 100 via the sensor device 201. For this purpose, the sensor means 211 here is also accessed, wherein the monitoring device 202 now detects objects in the vicinity of the vehicle 100 by means of its signal.

If, for example, another vehicle parks next to the vehicle 101, this is detected by the sensor means 211 and registered by the monitoring device 202. The monitoring device 202 can then, for example, start recording image data with a camera device (not shown here) in order to be able to determine the cause in the event of damage.

In such a case, the monitoring device 202 does not need to be designed to detect the manipulation to the vehicle 100 as such. As a result of the detected sensor signal, only the recording of image data that then, for example, has to be evaluated by the driver is started.

The monitoring device 202 can, however, also evaluate the signal provided by the sensor device 201 or the sensor means 211 and thus automatically detect parking damage, for instance. The evaluation can, for example, be carried out based on a comparison of the detected parameter with at least one threshold. If the evaluation reveals that the vehicle 100 was damaged or there is a risk of the vehicle 100 being damaged, the monitoring device 202 can take various actions.

By way of example, the monitoring device 202 can trigger an acoustic and/or visual alarm and, for example, sound the horn of the vehicle 100. This warns the driver of the other vehicle in time, meaning that damage can be prevented. It is, however, also possible that the driver of the other vehicle is alerted to the parking damage by means of the alarm signal such that (s)he does not inadvertently ignore the accident.

In the case of semi-autonomous or autonomous vehicles (e.g. level 3 to 5), the vehicle can also automatically move such that a collision or damage is prevented.

As a consequence of detecting an imminent manipulation or one that has occurred, a camera device may also be used for recording. It is also possible that a reference is made to one or more output devices, for example a smartphone. The police or the like may also be informed directly.

FIG. 2 shows an enlarged exploded view of the vehicle component 200 which has a damping device 1 with a magnetorheological-based damper.

The vehicle component 200 in FIG. 2 has connection units 51 and 52 for connection with the support structure 101 and the door 53 in order to pivot the door in a defined and controlled manner when moving from the open position illustrated in FIG. 1 to the closed position 2 also shown in FIG. 1.

The damping device 1 comprises a cylinder unit 31 in which the piston 38 of the piston unit 30 variably divides the cylinder volume 32 into a first chamber 33 and a second chamber 34.

A compensation volume 36 of a compensation chamber is intended to compensate for the piston rod 43 plunging into the cylinder unit 31.

FIG. 3 shows an enlarged cross-sectional view of a part of the vehicle component 200 from FIG. 2.

On the damping device 1 mounted and illustrated here in section, the piston unit 30 can be seen with the piston 38, in which the magnetic device 9 is arranged with the electrical coil 10. The piston 38 divides the cylinder volume 32 of the cylinder unit 31 into a first chamber 33 and a second chamber 34. The damping valve is arranged outside of the piston unit 31. The magnetic device 9 with the electrical coil 10 is arranged on the damping valve.

The compensation device with the compensation chamber 37 and the compensation volume 36 is also illustrated in the cylinder unit 31. The compensation chamber 37 is separated from the second chamber 34 by a separating piston that slides variably within the cylinder unit 31. It is also possible to place the compensation chamber on the other side, wherein there must then be sealing with respect to the piston rod passing through and the first chamber 33. The compensation chamber 37 is located on the low-pressure side of the one-way circuit. Valves for filling the first or second chamber 33, 34 and the compensation chamber 37 are provided. The compensation chamber 37 is filled with a gaseous medium under a low pressure so that the immersed volume of the piston rod 43 can be compensated.

A damping sensor 12, with which an absolute position of the damping device 1 can be detected here, is attached to the piston rod 43. By calling up the damping sensor 12, the position of the two connection units 51 and 52 relative to one another can be determined such that the angular position of the door 53 is also directly detected with the damping sensor 12.

The connection cables for the electrical coil in the piston 38 and damping sensor 12 are routed outward here through the piston rod 43.

The damping sensor 12 can be used as a sensor means 211 which is used by the monitoring device 202 for detecting the characteristic parameter for the manipulation of the vehicle 100. For example, if a change in the rotary angle of the door 53 is detected by the monitoring device 202 without the door device 50 being actuated by the driver, it can be assumed that the vehicle 100 has been manipulated.

The monitoring device 202 then starts, for example, the recording with a camera device or issues an alarm. Such an embodiment has the advantage that both very safe opening and closing of the door 53 and very straight-forward and inexpensive monitoring for parking damage are enabled by calling up the damping sensor 12.

FIG. 4 shows a version in which a piston rod or 2 piston rods 43, 44 passing through are provided. The inside of the cylinder unit 31 is divided again into 2 chambers 33 and 34 by the piston 38. Both piston rods 43 and 44 are guided outside at the respective ends here such that there is no need to compensate immersion of the volume of a piston rod. In order to be able to compensate for volume expansion due to temperature differences, a compensation device 39 is provided here which, for example, is designed as a hollow rubber ring or the like and in this respect provides corresponding volume compensation in the case of volume expansion or volume reduction caused by temperature differences.

Such a compensation device can be arranged in the chamber 33 or the chamber 34. Compensation devices in both chambers 33 and 34 are possible.

In all embodiments, the piston 38 is also designed as a damping valve 5 and has one or 2 or more flow channels 7 which connect the first chamber 33 with the second chamber 34. The chambers 33 and 34 are filled with a magnetorheological fluid 6. The damping is achieved here by a magnetic device 9 or at least one magnetic device 9 being arranged on the damping valve 5, which device comprises hard magnetic material and here also an electrical coil.

A short electrical pulse on the coil 10 triggers a magnetic pulse which leads to a permanent magnetization of the magnetic device 9 such that the flow resistance through the flow channel 7 subsequently increases according to the strength of the acting magnetic field 8.

Any desired damping of the door movement of the door 53 can be set as a result of corresponding re-magnetizations of the magnetic devices 9. Moreover, it is possible in addition to a permanently acting magnetic field, to use the coil 10 in order to dynamically model the magnetic field 8 of the magnetic devices 9. A magnetic field oriented in the same direction can increase the damping and a magnetic field oriented correspondingly in the opposite direction can attenuate the damping or even reduce it to zero.

In this exemplary embodiment, the connection cable(s) 42 is/are routed outward through the piston rod 44. The piston rod 44 is accommodated in a tube 46 so as to be displaceable. At the end of the piston rod 44, the connection cable 41 here is guided out of the piston rod and outward through a slot 42 in the tube 46.

By way of example for all exemplary embodiments, a control device 4 is shown in FIG. 4 with which the damping valve 5, damping device 1 and/or the entire door component 50 can be controlled. The control device 4 is operatively connected to the sensor device 201 such that the damping valve 5 can be controlled as a function of the sensor signals. The control device 4 may also be part of the vehicle 100 or another device.

FIG. 5 shows another version in which 2 magnetic devices 9 or at least 2 electrical coils 10 and 11 are provided. The magnetic coils 10 and 11 of the magnetic devices 9 are in turn arranged in the piston 38 of the piston unit 30 within the cylinder unit 31. Here too, the piston 2 divides chambers 33 and 34 of the cylinder volume 32. First and second piston rods 43 and 44 may be provided on both sides or just one piston rod is led out on one side. In such a case, a compensation chamber 37 with a compensation volume 36 becomes necessary again.

An electrical coil 10, 11 for producing a magnetic pulse and for permanently magnetizing the magnetic device 9 is used here. The respective other electrical coil 11, 10 can be used to modulate the currently acting magnetic field.

FIG. 6 shows another schematically illustrated version of a damping device 1 of a vehicle component 200 with connection units 51 and 52. The damping device 1 has a magnetorheological fluid 6 as operating fluid. A piston unit 30 with a piston 38 separates a first chamber 33 from the second chamber 34. At least one flow channel 7 leads through the piston. The one-way valve 15 opens for the flow of the magnetorheological fluid from the second chamber 34 into the first chamber 33. From there, the operating fluid is guided through the back channel 35 to the damping valve 5 which is external here and which is assigned a magnetic device 9 and an electrical coil 10 in order to set the desired damping. The damping valve 5 is in turn in flow communication with the second chamber 34 via a second one-way valve 16.

Both when the piston rod 43 is plunged into the cylinder unit 31 and when the piston rod 43 emerges from the cylinder unit 31, the operating fluid 6 flows in the same direction along the arrows shown. Depending on whether the piston rod is plunged or emerging, magnetorheological fluid is supplied to the compensation chamber 37 or magnetorheological fluid is removed from the compensation chamber 37. A compensation volume 36 which is filled with a gas is provided in the compensation chamber 37.

One or more damping sensors 12 can be provided in order to detect a relative position of the two connection units 51 and 52 to one another to derive an angular position of the door 53 therefrom. However, it is also possible in all embodiments that other angle sensors are provided, e.g. on the pivot joint, such that an angular position is given directly.

An electrical coil 10 for producing a magnetic pulse and for permanently magnetizing the magnetic device 9 is used here too. The same or else another electrical coil can be used to modulate the currently acting magnetic field.

FIG. 7 shows a schematic cross-section through the cylinder unit 31 and the piston 38 arranged therein. The flow channels 7 of the damping valve 5 are clearly seen, each of which is subdivided here into 2 partial channels by a partitioning wall. A magnetic field line of the magnetic field 8 is also shown. The magnetic field passes approximately vertically through the flow channels 7 of the damping valve. The electrical coil 10 is intended to produce a variable magnetic field and in particular also to output a magnetic pulse in order to magnetize the magnetic device 9 as desired.

In a corresponding manner, an external damping valve can, as illustrated in section in FIG. 7, also be designed for the vehicle component 200 according to FIG. 6, for instance. All parts depicted are then preferably immobile relative to one another. The flow channels 7 of the damping valve 5 can respectively be subdivided into two partial channels by a partitioning wall. The magnetic field passes approximately vertically through the flow channels 7 of the damping valve 5 again here too. The electrical coil 10 is intended to produce a variable magnetic field and can in particular also be used to output a magnetic pulse in order to permanently magnetize the magnetic device 9 as desired.

FIG. 8 shows an exemplary diagram of the functionality for an opening operation of a door 53. Normalized quantities for speed and deceleration are plotted against the angle. The curves of an uncontrolled speed 81 and the associated uncontrolled deceleration 84 as well as the curves of the controlled speed 82 and the associated controlled deceleration 85 are illustrated over an opening angle.

Furthermore, a threshold 80 for a limit acceleration and limit deceleration is shown. The threshold 80 is specified but can be set and changed.

If an actual deceleration exceeds the threshold 80, an acute hazardous situation is detected and hazard damping is triggered. This means in this case that the door movement is subsequently damped with maximum damping.

In this case, with an angle of almost 44°, the door encounters a previously undetected or unknown obstacle which subsequently slows down the door movement. As a result, the current deceleration of the door exceeds the predetermined threshold 80 with an angle of almost 45°.

It lasts a little while until a reliable value for the current deceleration is determined. In the meantime, the door has moved further and achieved an angle of approximately more than 45°.

As a result of exceeding the threshold 80, it can be recognized that a normal and trouble-free opening operation is not carried out here. If no countermeasure were taken here, the speed curve 81 and acceleration curve 84 would be above the angle, and the door would only come to a stop with, for example, an opening angle of almost 50°. This could already cause permanent damage to the door (or a neighboring car) or the like.

With the vehicle component 200, however, the door 53 is slowed down with the damping device 1 and in particular slowed down as much as possible as soon as possible or directly after the threshold has been exceeded. The door 53 is slowed down as it is assumed that the door has hit or is still hitting an obstacle. In this case, the outer panel of the door usually initially bends elastically such that additional slowing down of the door can completely prevent lasting damage to the door or other objects if necessary.

It the door hits a person, they may be injured. It is therefore all the more sensible and necessary to slow down the door in such cases.

The deceleration has increased abruptly and continues to increase due to the impact with the obstacle. Without further measures, the uncontrolled course of deceleration 84 would result. However, since the door is braked to the maximum possible extent after the threshold 80 has been exceeded, the controlled course of deceleration 85 and the controlled speed course 82 result.

The door is slowed down considerably more and, in this example, comes to a stop with an angle of almost 46°.

Due to the hazard damping, the door has come to a stop at an angular amount 87 of approximately 4° earlier (in particular without further near-field detection). The angular amount 87 is a direct measure for the energy absorbed and thus also reduction of the hazard. The numerical values given should only be understood as examples and are only initial values from tests. The exact values that can be achieved depend on many factors.

Control can be carried out completely via the position sensor or the angle sensor 12 of the damping device 1. Other values do not have to be entered but can be used.

The invention can also be very advantageously used when closing the door. To do this, you only need to imagine the diagram from FIG. 8 mirrored horizontally. If, during a closing operation, the door hits a body part of a user, for example, the deceleration of the door sharply increases straight away. The door is subsequently damped to the maximum extent and comes to a stop considerably earlier such that crushing of body parts or damage to objects can be reduced or prevented.

It is also possible and preferred that the door is brought to a stop during every closing operation at a specific small opening angle, for example at 2.5° or 3° in order to prevent fingers getting caught.

The door can thus also be smoothly brought to a stop in a targeted manner at certain adjustable or selectable points or positions. For this purpose, the door movement is damped accordingly before the desired position has been reached.

If environmental sensors or a near-field detection are active or if an obstacle 86 is known, the door movement is controlled such that the door comes to a stop and is fixed there, e.g. the angular distance 88 in front of the obstacle.

It is thus possible, for example, that greater or maximum damping is set practically straight away in the case of heavy deceleration of the door 53 in order to prevent damage as far as possible or at least reduce or minimize it. If the pivotable door 53 of the motor vehicle 100 is slammed shut and thus quickly moved in the closing direction and, for example, a leg or a hand or another object is in the path of the closing movement, the door 53 will initially strike the leg or the hand or an object and will be unexpectedly slowed down in this case. This means that an unexpected and unexpectedly high change in rotational speed occurs when the door rotates at a relatively high speed, for instance. This means here that the rate of change of the movement speed of the door device or, concretely in this case, the rate of change of the rotational speed exceeds a predetermined threshold.

When such a process is identified, maximum damping is set immediately such that damage can be very substantially prevented.

If, when opening the door 53, the outer panel of said door hits an obstacle, the rotational speed of the door is immediately considerably reduced. However, given that the panels can usually deform in a flexurally elastic manner over a certain area, damage to the door 53 can thus often be completely avoided in the case of an immediate reaction and maximization of the damping.

FIG. 9 shows a highly schematic diagram for the functioning of the vehicle component 200 according to the invention or the method. In this case, the vehicle component 200 is equipped with a camera device 203 for recording image data from the vicinity of the vehicle 100. The camera device 203 can also be suitable for recording image data from the interior of the vehicle 100 in order, for example, to be able to track the theft of an airbag or other vehicle components. The camera device 203 is then, for example, designed as an interior camera 230 and arranged in the passenger compartment.

The camera device 203 here is equipped with an image sensor 221. The image sensor 221 can, for example, be arranged in a side-view mirror and/or rear-view mirror. The image sensor 221 is used here to record incidents of damage and is also intended at the same time to detect the parameter for the manipulation of the vehicle 100. For this purpose, the image sensor 221 is operatively connected with the monitoring device 202 via the sensor device 201. The monitoring device 202 can use the evaluation of the image data to detect an imminent manipulation and/or one that has occurred to the vehicle 100. By way of example, approaching objects or vehicles can be reliably detected via the image sensor 221. It is, however, also possible that sensors other than the image sensor 221 are used for detecting the parameter, and the image sensor 221 is merely intended for documenting incidents of damage.

In particular, several image sensors 221 are provided for recording image data from different perspectives such that, for example, a top view and/or surround view and/or a panoramic image or a 360° image is/are possible.

The camera device 203 preferably comprises a storage device for recording the image data. The recorded data can be permanently stored there. However, it is also possible that the data is overwritten after a certain time if no manipulation has been determined. By way of example, images longer than 30 seconds or more or even less are deleted if no manipulation has been detected.

In the embodiment shown here, the image sensor 221 is intended additionally as a sensor means 211 for detecting the characteristic variable for obstacles in the movement space of the door device 50. Interfering objects or obstacles can therefore be detected when opening and closing the door 53. The signal of the image sensor 221 is then intended to control the damping device 1 such that the movement of the door can be damped to a maximum extent or blocked if the image data reveals obstacles.

This embodiment has the specific advantage that the image sensor fulfills a total of three functions and thus offers a particularly favorable cost-benefit ratio. It is used, on the one hand, as a sensor system for controlling the damping device 1 and, on the other hand, as a sensor for monitoring the vehicle 100 and additionally for recording incidents of manipulation.

In an alternative embodiment of the vehicle component 200, the image sensor 221 can also only be used for sensory detection of the parameter and/or variable and not for a camera device 203 for recording incidents of damage. Such an image sensor 221 can then, for example, be equipped with a substantially lower resolution such that particularly low energy consumption is possible.

If the monitoring device 202 then detects an imminent manipulation or one that has already occurred to the vehicle 100, a camera device 203 can use its own image sensor for recording. Recording can also be dispensed with altogether and, for example, an alarm signal or a message can be issued to a smartphone and/or smartwatch.

The image data recorded with the camera device 203 can also be transferred directly or immediately to an output device and/or to the police. This is hugely advantageous particularly for identifying a theft.

Various sensor means 211 are provided here to control the damping device 1. In other embodiments, only one of these sensor means 211 may also be provided or additional sensor means 211 may also be provided.

In the embodiment shown here, the sensor means 211 comprises a damping sensor 12. The damping sensor 12 is preferably designed as described with reference to FIGS. 2-8.

In addition, the image sensor 221 is also provided as a sensor means 211 for controlling the damping device 1. Furthermore, the sensor means 211 here further comprises a proximity sensor 251. This can be designed, for example, as an ultrasonic sensor and/or radar sensor or the like. Such a sensor system enables obstacles to be detected in a particularly reliable way when opening or closing the door 53.

The monitoring device 202 is operatively connected with the sensor device 201 here in such a manner that it can access the sensors 12, 221, 251 of the sensor means 211 and can use their signals to detect the parameter.

Further sensors, which can be accessed by the monitoring device 202, are associated with the sensor device 201 here. Other sensors can also be provided alongside the sensors shown here. The vehicle component 200 can, however, also be equipped with fewer or different sensors than those shown here.

In the purely exemplary choice shown here, these are a shock sensor 231 and a noise sensor 241. These sensors 231, 241 have the advantage that they only consume very little energy in operation and therefore do not adversely affect the power supply of the vehicle 100 even for prolonged monitoring. The vehicle 100 can therefore also be parked for a prolonged period of time in a parking lot, for example at an airport, without the vehicle battery being excessively drained by the monitoring. Nevertheless, the monitoring for shocks or noises provides very reliable detection of imminent manipulations or ones that have occurred to the vehicle 100.

The monitoring device 202 can here be operated in an economy mode with a reduced monitoring intensity. In economy mode, preferably only sensors with a low energy demand are accessed, for example the shock sensor 231 and/or the noise sensor 241.

When the parameter detected by these sensors 231, 241 exceeds a threshold, the monitoring device 202 switches from economy mode to power mode with a maximum monitoring intensity. In this power mode, the other available sensors are then accessed. This enables a high resolution of the monitoring and thus very reproducible detection of imminent manipulations.

The frequency of the call up of the sensors or the duration of the call ups can also be correspondingly refined or increased in power mode. In addition, the camera device 203 can also be switched on in power mode such that incidents of damage or thefts can be tracked. An alarm can also be issued as a warning when power mode is started.

The monitoring device 202 thus offers an intelligent call up of the sensor device 201 such that detailed but at the same time also very energy-saving monitoring is possible.

The sensor signals and in particular the signals of the sensors 231, 241 used in economy mode are evaluated here using at least one filter. For example, a shock sensor 231 or noise sensor 241 can thus distinguish between a truck merely driving past or a collision shock or imminent damage caused by a vehicle maneuvering very close by. The filter can, for example, comprise a high-pass filter and/or a band-pass filter.

As part of the evaluation, there may also be a comparison with at least one threshold such that, for example, the noise level can be taken into account for the noise sensor 241. In the case of the shock sensor 231, the strength of the shock can be detected, for instance.

As part of the evaluation, there can be a plausibility check in which at least two or more or also all sensor signals have to exceed a threshold in order to trigger the power mode and/or detect a manipulation.

In this case, the monitoring device 202 is also operatively connected with a positioning system 261. This enables the monitoring device 202 to determine at which position the vehicle 100 is parked. The positioning system 261 comprises, for example, at least one GPS sensor or wireless sensor.

In this regard, the monitoring device 202 either sets the economy mode or power mode based on the detected location of the vehicle 100. In particular, at least one assignment function is stored in the monitoring device 202 for this purpose, which assignment function assigns a location of the vehicle 100 either to the power mode or economy mode.

For example, monitoring can be done with a lower intensity or in economy mode if the vehicle 100 is parked at an airport as there is mostly long-term parking there. In addition, a prolonged stay can be assumed at such a location such that an energy-saving mode is particularly crucial.

By contrast, more intensive monitoring is highly advantageous in a parking lot of a shopping mall. In addition, the vehicle 100 is usually only parked there for a short amount of time such that the energy consumption is secondary. The risk of damage is likewise lower in a private parking space, such as at the driver's residence, meaning that economy mode is set.

Assignment can be done, for example, based on a user input. For example, the driver can save preferences for economy mode and power mode at preferred locations. In this case, it can be provided that either power mode or economy mode is automatically set at unknown locations or a user input is requested.

Assignment can also be done based on address books or digital maps such that the parking position is assigned to an address and, for example, a shopping mall.

It can also be provided that the driver stores in the monitoring device 202 by means of a user input whether and to what extent (s)he would like monitoring.

The monitoring device 202 can also set the economy mode and power mode as a function of the monitoring duration.

For example, economy mode is therefore initially set in the case of a very long selected monitoring duration. In addition, the monitoring device 202 can set the economy mode if a threshold for a monitoring duration is exceeded in order to conserve the vehicle battery.

The monitoring device 202 detects here whether an electrical energy storage device of the vehicle 100 is being charged. The power mode is preferably set there as the vehicles usually park close together at such charging stations and sufficient energy is also available.

A transmission device 204 is provided here to establish a connection to output devices, such as a smart device, smartphone or also a vehicle key or else to other vehicles and/or service stations or special receiving stations at parking lots, the police or monitoring services. An alarm or recorded image data can thus be directly transmitted if there is an imminent manipulation or if there is damage to the vehicle 100. The transmission device 204 can, for example, establish a mobile radio connection, in particular 5G standard, Bluetooth and/or WiFi connection or the like.

Automated sensor-controlled doors will be increasingly used in driverless vehicles or transport systems and particularly in robot taxis with a high customer frequency in order to enhance customer comfort but also to prevent damage to their own vehicles/doors as well as those of others when getting in and out of the vehicle. Due to the lack of operating personnel, damage detection and attribution and thus also the issue of liability are difficult in driverless vehicles. This is particularly critical in the case of personal injury.

The monitoring device described here, which for the purpose of detecting a characteristic parameter for a manipulation of the vehicle, for example damage to a vehicle outer shell, a removal of a vehicle interior component or personal injury, is operatively connected to the sensor device (201), can therefore be very advantageous.

Monitoring is not only possible and sensible when the vehicle is at a standstill but also whilst it is on the go. In this case, the near field around the vehicle and also the interior can be monitored. A passenger can thus be prevented from getting out or sticking their head or other body parts out of the vehicle interior recklessly/hazardously during the (slow) journey in a robot taxis, for instance. Intelligent networking of the sensors with the vehicle itself can, in this case, not only monitor and record but also attempt to actively prevent damage or injuries, for example by therefore bringing the vehicle to a standstill or autonomously swerving.

The sensors and here in particular the image recognition sensors of the vehicle can also be used to detect people, and the data can be processed and forwarded. In robot taxis, the interior can thus be adapted to the person, i.e. for example, the seat (seat height, legroom, backrest angle, massage seat etc.), the preferred music, the air conditioning. However, this is also advantageous for private vehicles or those driven by taxi drivers.

If children are detected, the doors can thus be preferably autonomously locked while the vehicle is in motion.

### REFERENCE LIST

| | |
|---|---|
| 1 | Damping device |
| 2 | Closed position |
| 3 | Open position |
| 4 | Control device |
| 5 | Damping valve |
| 6 | Magnetorheological fluid |
| 7 | Flow channel |
| 8 | Magnetic field |
| 9 | Magnetic device |
| 10 | Electrical coil |
| 11 | Electrical coil |
| 12 | Damping sensor, angle of rotation sensor |
| 13 | Angular position |
| 14 | Predetermined angular position |
| 15 | First one-way valve |
| 16 | Second one-way valve |
| 18 | Magnetic pulse |
| 19 | Period of time |
| 20 | Rate of change |
| 21 | Deceleration |
| 22 | Rotational speed |
| 23 | Threshold of 20 |
| 24 | Lower damping |
| 25 | Higher damping |
| 26 | Maximum damping |
| 27 | Damping |
| 28 | Closing speed |
| 29 | Second compensation channel |
| 30 | Piston unit |
| 31 | Cylinder unit |
| 32 | Cylinder volume |
| 33 | First chamber |
| 34 | Second chamber |
| 35 | Back channel |
| 36 | Compensation volume |
| 37 | Compensation chamber |
| 38 | Piston |
| 39 | Compensation device |
| 40 | Electrical connection unit |
| 41 | Connection cable |
| 42 | Slot |
| 43 | First piston rod |
| 44 | Second piston rod |
| 45 | Diameter of 43 |
| 46 | Tube |
| 50 | Door device |
| 51 | Connection unit |
| 52 | Connection unit |
| 53 | Door |
| 54 | Angular position |
| 60 | Obstacle |
| 80 | Threshold |
| 81 | Speed |
| 82 | Controlled speed |
| 84 | Deceleration |
| 85 | Controlled deceleration |
| 86 | Obstacle |
| 87 | Angular amount |
| 88 | Distance |
| 100 | Vehicle |
| 101 | Support structure |
| 200 | Vehicle component |
| 201 | Sensor device |
| 202 | Monitoring device |
| 203 | Camera device |
| 204 | Transmission device |
| 211 | Sensor means |
| 221 | Image sensor |
| 230 | Interior camera |
| 231 | Shock sensor |
| 241 | Noise sensor |
| 251 | Proximity sensor |
| 261 | Positioning system |
| 200 | Vehicle component |

1-21. (canceled)

22. A vehicle component for a vehicle with a door, the vehicle component comprising:
a sensor device having at least one sensor for detecting a characteristic variable for an obstacle in a movement space of the door;
a controllable damping device for damping a movement of the door, said damping device being controllable as a function of the variable;
a monitoring device operatively connected to said sensor device for accessing said sensor device and for acquiring therefrom at least one characteristic parameter for a manipulation of the vehicle.

23. The vehicle component according to claim 22, wherein the at least one characteristic parameter relates to damage to a vehicle outer shell or a removal of a vehicle interior component.

24. The vehicle component according to claim 22, wherein said sensor device comprises at least one image sensor for detecting the characteristic variable for the obstacle and/or the characteristic parameter for the manipulation.

25. The vehicle component according to claim 24, wherein said monitoring device comprises at least one camera for recording image data from at least one region of the vehicle and/or a vicinity of the vehicle.

26. The vehicle component according to claim 25, wherein said image sensor of said sensor device at least partly provides an image sensor for said camera.

27. The vehicle component according to claim 25, wherein said camera is controlled for activation and/or deactivation as a function of the characteristic parameter.

28. The vehicle component according to claim 25, wherein said camera is controllable to discard recorded image data if no manipulation is detected within a defined time window or to permanently store image data from a defined time window if a manipulation is detected.

29. The vehicle component according to claim 22, wherein said monitoring device is configured for issuing at least one alarm as a function of the characteristic parameter.

30. The vehicle component according to claim 22, wherein said monitoring device is configured for selective operation in an economy mode with a reduced monitoring intensity or in a power mode with an increased monitoring intensity.

31. The vehicle component according to claim 30, wherein said monitoring device is configured for setting the economy mode and/or power mode as a function of at least one parking position of the vehicle and/or as a function of at least one user input and/or as a function of at least one monitoring duration.

32. The vehicle component according to claim 30, wherein said monitoring device is configured for switching from economy mode to power mode as a function of the characteristic parameter.

33. The vehicle component according to claim 30, wherein said monitoring device is configured for accessing said sensor device only at a certain part and/or with a reduced frequency and/or with a reduced duration in order to reduce the monitoring intensity in economy mode.

34. The vehicle component according to claim 30, wherein said sensor device comprises at least one shock sensor and/or at least one noise sensor to be accessed by said monitoring device in economy mode.

35. The vehicle component according to claim 34, wherein said monitoring device is configured for processing the parameter detected by said shock sensor and/or noise sensor using at least one filter.

36. The vehicle component according to claim 22, wherein said monitoring device is configured for detecting a charging operation of an electrical energy storage device for a traction drive of the vehicle and to set the power mode as a consequence of the detection.

37. The vehicle component according to claim 22, wherein said sensor device for detecting the characteristic parameter has at least one sensor selected from the group of sensors consisting of an image sensor, a proximity sensor, a shock sensor, a noise sensor, an ultrasonic sensor, an infrared sensor, heat sensors, a radar sensor, a movement sensor, a force sensor, a pressure sensor, a strain sensor, an angle of rotation sensor, an acceleration sensor, and a vibration sensor.

38. The vehicle component according to claim 22, wherein said damping device is configured for determining at least one measure for a rate of change of a movement speed of the door based on said sensor and, in the case of a rate of change above a predetermined threshold, switching from a currently set low damping to a higher damping.

39. The vehicle component according to claim 22, wherein said monitoring device is configured for evaluating the measure for a rate of change of the movement speed of the door detected with the sensor as a parameter for a manipulation and, if the door is closed, detecting a rate of change above a predetermined threshold as a manipulation.

40. The vehicle component according to claim 22, wherein said damping device comprises magnetorheological fluid as operating fluid and at least one electrically adjustable magnetorheological damping valve, which is configured to maintain currently set state in a de-energized condition, in order to permanently set a damping property of the damping device as required via an electrical setting of the damping valve.

41. A method of operating a vehicle component, the vehicle component having at least one sensor device and at least one controllable damping device for damping a movable door, the method comprising:
detecting with a sensor of the sensor device at least one characteristic variable for an obstacle in a movement space of the door;
detecting with the sensor device at least one characteristic parameter for a manipulation of the vehicle and making the at least one characteristic parameter available to at least one monitoring device; and
controlling the damping device as a function of the characteristic variable.

42. A method of preventing damage to a vehicle, the method comprising:
providing the vehicle with a vehicle component according to claim 22;
detecting with a sensor of the sensor device at least one characteristic variable for an obstacle in a movement space of the door and controlling the damping device as a function of the variable;
detecting an evaluating at least one characteristic parameter for potential damage to a vehicle outer shell or a removal of a vehicle interior component from the vehicle, and causing the vehicle to autonomously attempt to prevent the manipulation of, or damage to, the vehicle.

43. A method for documenting damage to a driverless vehicle having a vehicle component with at least one sensor device and at least one controllable damping device for damping a movement of a door of the vehicle, the method comprising:
detecting with a sensor of the sensor device at least one characteristic variable for an obstacle in a movement space of the door;
detecting and evaluating with the sensor device at least one characteristic parameter for a manipulation of the vehicle, including damage to a vehicle outer shell or a removal of a vehicle interior component.
